(19) United States
(12) Patent Application Publication
(10) Pub. No.: US 2022/0306526 A1
(43) Pub. Date: Sep. 29, 2022

(54) THERMOCHROMIC MATERIALS

(71) Applicants: Nederlandse Organisatie voor toegepast-natuurwetenschappelijk onderzoek TNO, 's-Gravenhage (NL); Chemelot Scientific Participations B.V., Geleen (NL)

(72) Inventors: Pascal Jozef Paul BUSKENS, Kerkrade (NL); Zeger Alexander Eduard Pieter VROON, Eijsden (NL); Arnoldus Dominicus Maria Roberto HABETS, Epen (NL)

(21) Appl. No.: 17/595,789

(22) PCT Filed: May 29, 2020
(86) PCT No.: PCT/NL2020/050348

§ 371 Date: Nov. 24, 2021

(30) Foreign Application Priority Data
May 29, 2019 (EP) 19177286.2

(51) Int. Cl. C03C 17/25; C09K 9/00

(52) U.S. Cl. CPC C03C 17/25; C09K 9/00; C03C 2218/113; C03C 2217/228; C03C 2218/32; C03C 2217/70; C03C 2217/23; C03C 2217/24

(57) ABSTRACT

Described are thermochromic materials. Described thermochromic materials include materials comprising vanadium (IV) oxide and a solid component obtained from a precursor having film-forming properties. Also described are preparation methods for thermochromic materials.

### FIELD

The invention relates to materials comprising a thermochromic component.

### INTRODUCTION

Vanadium (IV) oxide (VO₂) is known as being able to undergo a fully reversible metal-to-semiconductor phase transition between a low temperature monoclinic phase VO₂ (M) and a high temperature rutile phase VO₂ (R). The rutile phase is a semi-metal, reflecting and/or absorbing a wide range of solar wavelengths e.g. in infrared. The monoclinic phase is a semiconductor and reflects and/or absorbs considerably less light, in particular less solar infrared light. It has been suggested to use VO₂ in window coatings to obtain glass windows for buildings which reflect and/or block more (near) infrared from sunlight with increasing temperatures. This can advantageously be used to decrease energy consumption for cooling of buildings with windows. The thermochromic switching temperature of VO₂ is 68° C. Doping with metal ions can be used to decrease the switching temperature e.g. to 25-30° C.

WO 2005/059201 describes use of atmospheric pressure chemical vapour deposition (APCVD) for producing a film of thermochromic transition metal-doped VO₂ on a substrate.

EP 2368858 (describes a method of manufacturing a panel, the method including spraying a coating solution including a thermochromic material and a silicon oxide on a surface of a transparent substrate, and drying the coating solution to form a coating film on the surface of the substrate. In Experimental example 1 of EP 2368858, a SiO₂ sol solution is applied coated and the coating film was sintered at a temperature of 300° C. for 1 hour. In Experimental example 3 of EP 2368858, a SiO₂ sol solution and V(OR)₄ is diluted, followed by coating and sintering the resulting solution. EP 2368858 uses SiO₂ for adjusting (decreasing) the refractive index of the coating.

An object of the present invention is to provide a thermochromic material having improved properties. The material according to an aspect of the invention has for instance a high increase in transmission in infrared when switching from the high temperature state (above the switching temperature) to the low temperature state (below the switching temperature). The material has for instance a low switching temperature. The material has for example good scratch resistance.

### SUMMARY

The invention pertains in a first aspect to a thermochromic material comprising: vanadium (IV) oxide and a solid component obtained from a precursor having film-forming properties, wherein the thermochromic material exhibits a transmission increase in infrared (800-2400 nm) from above the switching temperature to below the switching temperature that is larger than said transmission increase for a reference material not including said solid component; and/or wherein the thermochromic material exhibits a switching temperature that is at least 5° C. lower than for a reference material not including said solid component.

The invention further pertains to a method of preparing a coated article comprising a substrate and a coating on the substrate, wherein the coating comprises vanadium (IV) oxide and silica, wherein the method comprises: applying a coating formulation comprising a precursor of vanadium (IV) oxide and silica onto a substrate to give a coated substrate, thermally treating the coated substrate under an atmosphere comprising oxygen at a level of less than 1000 ppm by volume and at a temperature of at least 350° C. for a period of less than 60 minutes.

The invention further pertains to a method of preparing a composition, e.g. a pigment composition, comprises vanadium (IV) oxide and silica, wherein the method comprises: providing a formulation comprising a liquid medium, a precursor of vanadium (IV) oxide and silica, drying said formulation to remove at least part of said liquid to give a dried material, and thermally treating the dried material under an atmosphere comprising oxygen at a level of less than 1000 ppm by volume and at a temperature of at least 350° C. for a period of less than 60 minutes. The invention further pertains to the use of silica as additive in a thermochromic material comprising vanadium (IV) oxide, for reducing the surface roughness of a coating of said thermochromic material, and preferably for additionally for enhancing the transmission increase in infrared (800-2400 nm) from above the switching temperature to below the switching temperature, wherein the transmission increase is preferably measured according to Method A as described herein.

The invention pertains further to a thermochromic material comprising: vanadium (IV) oxide and a solid component, wherein the solid component comprises SiO₂, ZrO₂, TiO₂, Al₂O₃, HfO₂, MgF₂, CaF₂, an organosiloxane compound, or a mixture thereof. Preferably the thermochromic material comprises vanadium (IV) oxide and SiO₂. The invention further pertains to a coated article comprising a substrate and a coating, the coating comprising said thermochromic material and having a surface roughness of less than 10 nm. The surface roughness is preferably measured using Method B described herein.

### BRIEF DESCRIPTION OF THE DRAWINGS

FIG. 1 illustrates a measurement method used in the examples described herein.

### DETAILED DESCRIPTION

The invention pertains in an aspect to a thermochromic material. The material comprises a thermochromic component. The thermochromic component is typically but not exclusively vanadium (IV) oxide. The material furthermore comprises a solid component. The material is a solid material at ambient conditions (20° C. and 0.10 MPa). The material is for instance a granular material or for instance a coating on a substrate. A granular material is for instance a particulate material. A granular material is for instance a powder or comprises for instance flakes or granules. A coating comprises for instance a coating layer of the material on a substrate. The coating layers layer is for instance less than 0.10 mm thick, or less than 20 μm or less than 10 μm, or even less than 1.0 μm thick or less than 500 nm thick. For example the layer is 10 nm to 200 nm thick. The substrate comprises for instance glass for instance based on silica. The substrate comprises for instance a non-crystalline, amorphous solid. Optionally further layers are present between the thermochromic material coating and the substrate.

The thermochromic material comprises a solid component. The solid component is for instance obtained from a precursor having film-forming properties. The precursor is for instance suitable for film forming with a sol-gel process. The precursor is for instance a colloidal suspension of particles in a liquid medium. The precursor is for instance a sol. The transformation of a precursor in the form of a sol into (a part of) the thermochromic material may in some embodiments proceed through a stage wherein the precursor is or is comprised a gel. In some other embodiments a sol precursor for the solid component is transformed into a part of the thermochromic material without passing through a gel stage.

Including the solid component in the thermochromic material may for instance contribute to good scratch resistance and other mechanical properties. In particular the film-forming properties of the precursor for the solid component may contribute to such properties, for instance by providing the solid component as a matrix for the thermochromic component.

Including the solid component was surprisingly found to improve optical properties of the thermochromic component as is illustrated in the examples. For instance the solid component can surprisingly provide for improved ΔIR as is illustrated in the examples.

The solid component is different from the thermochromic component. If the thermochromic component is VO₂, then the solid component is different from VO₂.

The solid component comprises for instance one or more compounds selected from the group consisting of a metal pnictogen (comprising e.g. N or P atoms), a metal chalcogen (comprising e.g. O, S or Se atoms), a metal halogen (comprising e.g. F, Cl, Br or I atoms), or a combination thereof. The solid component comprises for instance a compound comprising a metal atom bound to an atom selected from the group consisting of N, P, O, S, Se, F, Cl, Br, or I, for example a metal atom bound to an atom selected from the group consisting of O or F. The compounds include for instance a metal atom. The solid component comprises for instance one or more compounds selected from the group consisting of metal oxides, metal fluorides, metal sulphides or metal nitrides, hybrid materials combining such metal compounds with organic compounds, and organometallic compounds. The solid component comprises for instance one or more selected from the group consisting of metal oxides and metal fluorides. A metallic element in said compound is for instance selected from the group consisting of alkaline earth metals, transition metals, actinides, lanthanides, post-transition metals and metalloids. Metalloids include for instance the elements B, Si, Ge, As, Sb, and Te. As used herein, metals include Si. In particular metal atoms include Si atoms. Post-transition metal elements include for instance Al, Ga, In, Sn, and Pb. The example metal elements comprised in said example compounds of the solid component include for instance Si, Zr, Ti, Al, Hf, Mg, and Ca. The compound comprised in the solid component including the metal atoms as discussed does not need to be a molecular compound.

The solid component comprises for instance SiO₂, ZrO₂, TiO₂, Al₂O₃, HfO₂, MgF₂, CaF₂, an organosiloxane compound, or a mixture thereof.

The solid component can for example comprise an organosiloxane compound. The solid component can for example comprise a compound comprising a backbone of alternating silicon-oxygen [Si—O] units with organic side chains attached to one or more or each Si atom. The organosiloxane compound is for instance obtained using an organosilane compound.

The solid component can for example comprise an organosilica material, for instance a silica-based compound containing organic groups. The solid compound can for instance comprise an organically modified silica material. Such materials can for instance be prepared by adding a silane compound to a silica-derived gel, for instance using an organosilane and alkoxysilane during a process wherein a sol is formed.

The solid component is for instance crystalline or amorphous.

The solid component can for instance comprise a metal oxide, which is for instance obtained by hydrolysis and condensation of a metal alkoxide compound provided e.g. as a sol in a liquid medium.

The solid component can for instance comprise a metal fluoride, which is for instance obtained by a fluorolytic method from a precursor. The precursor is for instance a metal alkoxide. The precursor is for instance provided as a sol in a liquid medium.

The solid compound has for instance a refractive index for 589 nm light of less than 2.50, less than 2.30 or less 2.0 or less than 1.90 or less than 1.50, for instance at 20° C.

The material comprises for instance at least 50 wt. % or at least 60 wt. % VO₂, relative to total weight of the material. The material comprises for instance at least 0.10 wt. % of the solid component, more preferably at least 1.0 wt. % and/or preferably maximum 50 wt. %, such as 5 to 25 wt. % relative to the total material. The material comprises for instance at least 1.0 wt. % and/or less than 50 wt. % of one or more of SiO₂, ZrO₂, TiO₂, Al₂O₃, HfO₂, MgF₂, CaF₂, and organosiloxane compounds, based on these compounds in total relative to total material. The material comprises for instance at least 1.0 wt. % and/or less than 20 wt. % of SiO₂, relative to the total material.

The material comprises for instance V and Si atoms in an atomic (number of atoms) ratio of V:Si of at least 1.0, at least 2.0, at least 4.0 or at least 5.0 or at least 6.0 and preferably less than 20 or less than 10, such as in a ratio V:Si atoms of 2 to 20, 2 to 10, or 5 to 15.

The material comprises for instance at least 20 vol. % or at least 25 vol. % or at least 50 vol. % and/or for instance less than 90 vol. % VO₂ relative to the total material. The material comprises for instance at least 5.0 vol. % or at least 10 vol. % and/or less than 90 vol. % of the solid component relative to the total material. The material comprises for instance at least 5.0 vol. % or at least 10 vol. % and/or less than 90 vol. % SiO₂ relative to the total material excluding porosity. The material comprises for instance at least 5.0 vol. % or at least 10 vol. % and/or less than 90 vol. % of one or more of SiO₂, ZrO₂, TiO₂, Al₂O₃, HfO₂, MgF₂, CaF₂, and organosiloxane compounds, based on these compounds in total relative to total material. The volume percentages are for instance measured at 20° C. and 0.1 MPa and for instance using inductive coupled plasma-optical emission spectroscopy for the determining the elemental rates and FTIR for confirmation of the species for the relevant elements. The volume percentages are for instance based on solid components excluding porosity.

The thermochromic material comprises optionally one or more doping ions. The doping ions are for instance ions of W, Ta, Nb, Mo, Al, F, or a mixture of these ions. Doping ions can be used for decreasing the switching temperature. The material includes the doping ions for instance in an atomic ratio (number of atoms) of V atoms to doping ions of at least 30 or at least 100 and typically less than 2000, based on doping ions in total. The material for example includes W in an atomic ratio (by number of atoms) of V atoms to W atoms of e.g. more than 10 and/or less than 2000, such as in the range of 50-500. As used herein, ionic species are counted as atoms.

It was surprisingly found that the inclusion of a solid component as discussed, such as for example one or more of SiO₂, ZrO₂, TiO₂, Al₂O₃, HfO₂, MgF₂, CaF₂, and organosiloxane compounds, in particular SiO₂, in the thermochromic material improves the ΔIR as well as advantageously reduces the switching temperature. Additionally the solid component, such as e.g. SiO₂, may advantageously reduce the surface roughness of the coating.

In particular materials can be obtained that have a higher ΔIR in combination with a low switching temperature (even below 25° C.). The materials and such combination of properties enable practical application such as smart windows which are window glass provided with the thermochromic material of the invention. However, the materials can also be used for other applications, such as pigments.

The invention pertains in an aspect to a thermochromic material comprising VO₂ and a solid component as discussed, wherein the thermochromic material exhibits a transmission increase in infrared (800-2400 nm) from above the switching temperature to below the switching temperature that is larger than said transmission increase for a reference material not including said solid component, and/or wherein the thermochromic material exhibits a switching temperature that is at least 5° C. lower than for a reference material not including said solid component. The switching temperature is for instance the temperature at 0.5 hysteresis width in a plot of transmission at 1600 nm as function of temperature. The detailed determination of the switching temperature is for example as described in Example 1, in particular Method A described herein. The transmission is for instance as measured using heating and cooling at a rate of 1° C./min at 2° C. intervals in a temperature range of 0° C. to 90° C. The transmission increase is determined for example as transmission modulation value. The reference material is identical to the measured material except for not containing the solid component. The reference material is for instance obtained from a precursor mixture that is identical to that used for an example measured material except that the precursor solution for the solid component is omitted.

The invention also pertains to a coated article comprising a substrate and as coating a thermochromic material as described herein. The substrate is for instance a window glass. The window glass is for instance a glass panel. The glass panel has for instance a width of at least 0.10 m or at least 0.5 m and a length of at least 0.10 m or at least 0.50 m. The substrate for instance comprises silica. The substrate is for instance a glass substrate. The coating for example has a surface roughness of less than 10 nm, measured as Pq. Pq indicates the root mean square deviation of the primary or the raw profile P. The property Pq can be measured according to ISO 4287:1997 and e.g. measured using a stylus profile meter, such as according to Method B described herein. The coating has a thickness of e.g. at least 20 nm and/or maximum 100 nm, e.g. at least 20 nm and/or maximum 50 nm and is e.g. a single layer coating. The thickness can be measured using a stylus profilometer, e.g. with the method used in Example 1. The coated article is made for instance with a preparation method as described herein.

Also provided is coated article comprising a substrate and a coating layer comprising a thermochromic material which comprises vanadium (IV) oxide and a solid component comprising SiO₂, ZrO₂, TiO₂, Al₂O₃, HfO₂, MgF₂, CaF₂, and/or an organosiloxane compound, wherein the coating layer has a surface roughness (Pq) of less than 10 nm. The surface roughness can be measured as specified above. The thermochromic material of the coating layer preferably has the features as described herein for the thermochromic material. Preferences for the substrate are preferably as described herein. The coating layer has a thickness of e.g. at least 20 nm and/or up to 100 nm, e.g. at least 20 nm and/or up to 50 nm and is e.g. a single layer coating. The thickness can be measured using a stylus profilometer, e.g. with the method used in Example 1. The coated article is e.g. made with the preparation method as described herein.

The invention also pertains to the thermochromic material as discussed in granular form. The thermochromic material in granular form is for instance a pigment composition, for instance an IR pigment. The thermochromic material is for instance a powder, in an embodiment the thermochromic material is in particulate form. The invention also pertains to an article comprising the thermochromic material in granular form, e.g. comprising particles of thermochromic material. The article is e.g. a foil or a film. The comprises the particles of the thermochromic material and e.g. a matrix such as a polymer matrix. The film comprises e.g. a layer comprising particles of the thermochromic material and a matrix and optionally additional layers, these layers are e.g. laminated. The additional layers e.g. include a polymer film. The thermochromic material has for instance, optionally, a particle size in the range of at least 10 μm and/or up to 5 mm, for instance measured (especially for an optional of at least 10 μm) using a laser diffraction particle size analyzer, and volume equivalent sphere diameter and volume weighted average. However, e.g. also smaller particle sizes are possible. The thermochromic material in granular form, e.g. the pigment composition, is for instance incorporated into a film or foil. The film comprises e.g. a polymeric matrix. The film is e.g. adhesive or self-adhesive. The film e.g. comprises a laminate comprising one or more polymeric layers and one or more layers comprising the thermochromic material. A layer comprising the thermochromic material is e.g. a composite layer comprising particles of the thermochromic material and a matrix, e.g. a polymeric matrix. Such a film is e.g. prepared by a method comprising a step of casting a slurry comprising a liquid phase, a polymer, and particles of the thermochromic material. The casted film is e.g. laminated with other films to produce a laminated film comprising particles of the thermochromic material.

The film or foil can e.g. be applied to float glass, glass windows and glass panels. This can be used e.g. for renovating buildings.

The invention also pertains for a method of preparing a thermochromic material, preferably a thermochromic material as discussed. The method comprises a step of thermally treating a precursor mixture under an atmosphere comprising oxygen at a level of less than 1000 ppm by volume and at a temperature of at least 350° C. for a period of less than 60 minutes. The precursor mixture comprises a precursor for VO₂ and the solid component or a precursor for the solid component. For example, if the solid component comprises silica, the precursor mixture comprises for instance silica, for instance in the form of silica nanoparticles. The precursor for VO₂ comprises for instance an organometallic vanadium complex. The precursor mixture comprises for instance less than 10 wt. % liquid components at room temperature at the initiation of the thermal treatment step, relative to total precursor mixture. The precursor mixture is for instance prepared with a method comprising a step of drying a liquid precursor mixture so as to remove a liquid medium which is used e.g. as solvent and/or for suspending nanoparticles.

The thermal treatment for instance involves heating the precursor mixture in less than 5000 s to a temperature above 400° C., for instance from an initial temperature of less than 50° C. or less than 30° C. The thermal treatment for instance comprises cooling the precursor mixture, after said heating step, from a temperature of at least 400° C. to a temperature of less than 300° C. in a period of less than 1 hour, for instance in less than 300 s. The cooling is for instance done under controlled atmosphere with inert gas (e.g. N₂) and less than 500 ppm by volume oxygen. The cooling rate can be controlled using the gas flow rate. Such cooling may advantageously contribute to the good optical and mechanical properties of the coating.

The precursor mixture is for instance a dried coating on a substrate or a dried precursor liquid mixture. The thermal treatment provides for instance for sintering or annealing. The material after thermal treatment is for instance a coating on a substrate or a solid granular material.

In an advantageous embodiment, the preparation method is a method of preparing a coated article comprising a substrate and a coating on the substrate, wherein the coating comprises vanadium (IV) oxide and silica. The method comprises applying a coating formulation comprising a precursor of vanadium (IV) oxide and silica onto a substrate to give a coated substrate. The coating formulation comprises for instance a silica sol. The method further comprises thermally treating the coated substrate under an atmosphere comprising oxygen at a level of less than 1000 ppm by volume and at a temperature of at least 350° C. for a period of less than 60 minutes. The method may comprise a step of drying after the coating is applied and prior to the thermal treatment step. The drying is for instance based on evaporation, e.g. involves vacuum drying, and is for instance done at a temperature not higher than 100° C., such as entirely at a temperature of less than 50° C. In an example embodiment, the coating formulation comprises V and Si atoms in an atomic (number of atoms) ratio of V:Si of at least 1.0, at least 2.0, at least 4.0 or at least 5.0 or at least 6.0 and preferably less than 20 or less than 10, such as in an atom ratio V:Si of 2 to 20, 2 to 20, or 5 to 15. Herein the ratios are based on including ionic species.

In an embodiment, the preparation method is a method of preparing a thermochromic material which preferably is a granular composition, such as a powder composition, e.g. a pigment composition, comprising VO₂ and SiO₂. Hence, a method is provided for preparing a thermochromic material comprising VO₂ and a solid component, wherein the solid component is preferably SiO₂. In an embodiment, the preparation method is a method of preparing a granular composition, such as pigment composition, comprising VO₂ and SiO₂.

The method comprises providing a formulation comprising a liquid medium, a precursor of vanadium (IV) oxide and silica. The formulation comprises for instance a silica sol. The precursor of VO₂ is for instance a vanadium complex. The method comprises a step of drying the formulation to remove at least part of said liquid from the formulation, e.g. by evaporation, to give a dried material. The drying is for instance done entirely at a temperature lower than 100° C., such as lower than 50° C. The method further comprises a step of thermally treating the dried material under an atmosphere comprising oxygen at a level of less than 1000 ppm by volume and at a temperature of at least 350° C. for a period of less than 60 minutes.

Optionally, the obtained solid product is comminuted into a powder using a size reduction technique such as milling. The solid component may be a solid component as described herein, such as comprising SiO2, ZrO2, TiO2, Al2O3, HfO2, MgF2, CaF2, an organosiloxane compound, or a mixture.

In an embodiment, the formulation comprising a liquid medium, a precursor of vanadium (IV) oxide and a precursor of the solid component. The precursor of the solid component has e.g. film-forming properties.

In an example preparation method of the present invention for preparing a thermochromic material, preferably a thermochromic material as discussed, the material is thermally treated (e.g. is sintered) at a temperature of at least 350° C., preferably at least 400° C., more preferably at least 450° C., for instance less than 800° C., for example in the range of 400° C. to 500° C. The sintering is done as said temperature for a period of less than 60 min, preferably less than 40 min, more preferably less than 30 min, and for instance for a period of more than 2 minutes, or more than 5 minutes, for example for a period of 5 to 20 minutes or 10 to 25 minutes at a temperature in said ranges. The sintering is done under an atmosphere comprising less than 1000 ppm (by volume) O₂, more preferably less than 500 ppm or less than 200 ppm oxygen (by volume). Preferably, these ranges for oxygen content, sintering temperature and sintering duration are used in combination.

In a preferred embodiment, the sintering is done at a temperature of at least 400° C., preferably 400 to 500° C., with a duration of max. 20 minutes, e.g. 10-20 minutes, and with an oxygen content of less than 200 ppm by volume, preferably less than 150 ppm by volume.

Thermochromic materials prepared in this way may advantageously have a good (large) ΔIR. Furthermore the materials prepared in this way may advantageously have relatively low switch temperature. The described preparation method, in particular the thermal treatment step, is furthermore advantageously fast.

The invention also pertains to thermochromic materials obtained by or obtainable by the preparation methods as described. These thermochromic materials preferably have the composition and properties as described.

The invention further pertains to the use of a solid component comprising SiO₂, ZrO₂, TiO₂, Al₂O₃, HfO₂, MgF₂, CaF₂, an organosiloxane compound, or a mixture thereof, preferably silica (SiO₂), as additive in a thermochromic material comprising vanadium (IV) oxide, for reducing the surface roughness of a coating of said thermochromic material, and/or preferably for additionally for enhancing the transmission increase (ΔIR) in infrared (800-2400 nm) from above the switching temperature to below the switching temperature. The reduced surface roughness may advantageously provide for improved mechanical stability and fouling resistance of coating comprising the thermochromic material. The reduced surface roughness may advantageously provide for improved scratch resistance. These advantages are in particular important for applications as ‘smart window glass’. The preferred use for obtaining transmission increase is preferably measured as discussed hereinabove and as illustrated in the following examples. This preferred surprising effect of an improved ΔIR provided by such a solid component as additive opens a new scope of application of the additive for improving optical properties of the thermochromic material.

### EXAMPLES

The invention will now be further illustrated by the following non-limiting examples.

### Example 1

Pre-Treatment of Glass Substrate

Pilkington Optiwhite™ glass of 4 mm is cut to a size of 10.0×10.0 cm. The resulting plates are placed into a Branson 5510 ultrasonic bath filled with mixture D used for cleaning. The bath is heated till 60° C. The material is ultrasonicated for 4 h and left in the bath for another 20 h. The glass is then removed from the bath, rinsed with demineralized water 18.2 mΩ*cm at 25° C., and left to dry at ambient conditions. Glass substrates which did not displayed a homogeneous wetting of water with a contact angle lower the 10° were rejected.

Applying Barrier Coating

The barrier coating was applied on both sides of the glass substrates using dip coating. For this purpose mixture B was used. The substrates were submerged into and retracted from mixture B at 2.0 mm/s with a holding time of 5 seconds. After complete retraction from mixture B, the coated glass substrates were left to dry for 5 minutes at <35% rH (relative humidity) and 19-25° C. after which they were placed into furnace. The coated glass substrates were annealed (e.g. under air) at a temperature of 450° C. for 1 h. The annealed coated glass substrates were rinsed with demineralized water 18.2 mΩ*cm at 25° C., then dried at ambient conditions.

Applying Thermochromic Coating

The thermochromic coating was applied single-side of the glass substrate using dip-coating. To achieve this, one-side of the barrier coated glass substrate was masked using D-c-fix® self-adhesive foil. The substrates were submerged into and retracted from a formulation (see Table 1) which at least contains mixture A, and comprises amounts of mixture B and/or C, at 2.0 mm/s with an holding time of 5 seconds. After complete retraction from mixture B, the coated glass substrates were left to dry for 5 minutes at <35% rH (relative humidity) and 20-25° C. Subsequently the masking foil was removed and the coated glass substrate was placed onto a 6 inch silicon wafer in the Rapid Thermal Processor, with the non-coated side of the glass-substrate facing the silicon wafer.

Thermal Treatment

The sample (glass substrate with applied coating dried at ambient) was then placed into a Jipelec™ Jetfirst PV Rapid Thermal Processor. In a pre-set atmosphere containing a controlled level of oxygen of less than 500 ppm by volume of oxygen in nitrogen, the silicon wafer with coated substrate, glass side facing the lamps used for heating, was heated in 500 to 1000 seconds till a temperature in the range of 300-500° C. Subsequently the material was further heated till a temperature 10 to 50° C. higher for more than 500 seconds, after which it was kept isothermal for 30 seconds. The gas flow throughout the complete heating cycle was set at 200 to 1000 cm³/min whilst retaining the oxygen to nitrogen ratio. After the isothermal step the gas flow was reduced and cooled to approximately 250° C. The gas flow was at that time increased to above 1000 cm³/minute. The glass containing the final product was removed from the oven at a temperature below 150° C. and used as such. The thermal treatment was identical for all samples.

Solutions

Solution A: vanadyl oxalate, 0.27 mol/kg. A 500 ml glass bottle with wide bottleneck, equipped with an overhead stirrer and a funnel, is placed in an oil-bath, pre-heated till 80° C. Into the bottle is added 70.2 g oxalic acid (0.780 mol) and subsequently 18.0 g water (1.0 mol). This is then stirred for 15 minutes. The mixture is a white slurry. After 15 minutes, the addition of the 33.0 g vanadium pentaoxide (0.182 mol) is started. Small amounts of approximately 1 g are added via the funnel at intervals of circa 1 minute. After the complete addition of the vanadium pentaoxide the reaction mixture is stirred for another 0.75 h at 80° C. Subsequently the oil bath is removed and the reaction mixture is allowed to cool to ambient temperature, simultaneously the mixture is diluted using 150 g 2-propanol (2.50 mol). After one hour stirring at room temperature, the reaction can be diluted till the desired concentration of V⁴⁺ ions (see “Formulation preparation”).

Solution B: This solution (colloidal sol) is prepared following the method described in J. Langanke et al., Journal of Sol-Gel Science and Technology 2013, 67, 282-287. The silica solution (sol) is prepared by the addition of 156.3 g tetraethoxysilane (0.75 mol) to a solution of 347.3 g of iso-propanol and 135 g demineralized water 18.2 mΩ*cm at 25° C. After the addition of 4.5 g glacial acetic acid (0.075 mol) under vigorous stirring, the formulation is moderately stirred for additional 24 h at room temperature. Afterwards the formed sol is diluted with 3113.4 g iso-propanol and acidified by the addition of 1.5 g concentrated nitric acid. Liquid B is a silica sol.

Solution C: W at 0.052 mol/kg. For the preparation of the tungsten solution, 1.98 g of tungsten hexachloride (5.0×10⁻³ mol) was added to 93.2 g 2-propanol (1.55 mol) whilst being stirred. After one hour this solution was used as such. Final concentration of W ions in solution C is 0.052 mol/kg.

Solution D: The cleaning solution for purpose of cleaning of glass substrates is made by the addition of 310 g of NH₄OH 30% wt in water, followed by 186 g of hydrogen peroxide 50 wt. % in water to 9000 g of demineralized water 18.2 mΩ*cm at 25° C. This is stirred for 0.25 h and then used as such.

Formulation Preparation

To Mixture A was first added 2-propanol until a concentration was achieved of 0.2 mol/kg whilst stirring. Subsequently mixture C was added, followed by stirring for 5 minutes. After 16 hours mixture B was added to the mixture of A and C, stirred for 5 minutes, and left for 24 hours. The amounts of the solutions are as in Table 1. After 24 hours the formulations can be used as such.

TABLE 1

| Formulation | Mixture A (g) | Mixture B (g) | Mixture C (g) |
|---|---|---|---|
| 1 | 125 | 24.27 | 0 |
| 5 | 125 | 24.27 | 14.5 |
| 8 | 125 | 0 | 0 |
| 12 | 125 | 0 | 14.5 |

Results

The results are shown in Table 2 and Table 3. For instance, for sample 1 (VO₂+SiO₂), the transmission IR is 21% higher at a low temperature (below the switching temperature) than at a high temperature (above the switching temperature) (percentage point; i.e. Δ=79.1%−58.1%), whereas for the comparative sample 8 (VO₂) the increase is 20.4%. This demonstrates the advantage of using SiO₂ in the coating. The advantage is even more surprising because the sample 1 (VO₂+SiO₂) is much thinner (average 35 nm) than sample 8 (VO₂) which has an average thickness of 78 nm (see Table 5). In the same way, also in the presence of W, SiO₂ provides for a larger ΔIR (16.7% vs. 13.5%).

TABLE 2

| Δ (%) | Sample 8 | Sample 1 | Sample 12 | Sample 5 |
|---|---|---|---|---|
| (Tlow-Thigh) | VO2 | VO2 + SiO2 | VO2 + W | VO2 + SiO2 + W |
| Trans. Vis | −0.6 | 0.2 | −0.1 | 3.4 |
| Trans. IR | 20.4 | 21 | 13.5 | 16.7 |
| Refl. Vis | 1.4 | 4.2 | 1.7 | −2.5 |
| Refl. IR | −2 | −1.4 | −2.1 | −4.1 |
| Abs. Vis | −0.7 | −4.2 | −1.5 | −0.9 |
| Abs. IR | −18.3 | −19.7 | −11.4 | −12.5 |

Trans = transmission; Refl = reflection; Abs = absorption; Vis = 400-700 nm; IR = 800-2400 nm.

TABLE 3

| | | Transmission (%) | | | | Reflection (%) | | | | Absorption (%) | | | |
|---|---|---|---|---|---|---|---|---|---|---|---|---|---|
| | | Visible | | IR | | Visible | | IR | | Visible | | IR | |
| | | (400- | | (800 nm- | | (400- | | (800 nm- | | (400- | | (800 nm- | |
| | | 700 nm) | | 2400 nm) | | 700 nm) | | 2400 nm) | | 700 nm) | | 2400 nm) | |
| | | Low | High | Low | High | Low | High | Low | High | Low | High | Low | High |
| # | Coating | T | T | T | T | T | T | T | T | T | T | T | T |
| 8 | VO2 | 57.9 | 58.5 | 81.0 | 60.6 | 15.9 | 14.5 | 11.3 | 13.3 | 26.2 | 26.9 | 7.8 | 26.1 |
| 1 | VO2 + | 62.7 | 62.5 | 79.1 | 58.1 | 18.4 | 14.2 | 9.4 | 10.8 | 19.0 | 23.2 | 11.5 | 31.2 |
| | SiO2 | | | | | | | | | | | | |
| 12 | VO2 + | 62.3 | 62.4 | 72.7 | 59.2 | 14.5 | 12.8 | 9.0 | 11.1 | 23.2 | 24.7 | 18.3 | 29.7 |
| | W | | | | | | | | | | | | |
| 5 | VO2 + | 68.1 | 64.7 | 78.1 | 61.4 | 12.0 | 14.5 | 6.7 | 10.8 | 19.9 | 20.8 | 15.2 | 27.7 |
| | SiO2 + | | | | | | | | | | | | |
| | W | | | | | | | | | | | | |

Furthermore, the coating samples including SiO₂ had a lower switching temperature than reference coating samples not including SiO₂, as shown in Table 4. The switch temperature was measured for 1600 nm IR light.

TABLE 4

Sample

| | |
|---|---|
| VO₂ | VO₂ with SiO₂ |

| | |
|---|---|
| % mol | Switch temperature (° C.) |
| WCl₆ | at 1600 nm |

| | | |
|---|---|---|
| 0 | 65.7 | 60.5 |
| 1 | 40.6 | 37.9 |
| 2 | 26.4 | 29.8 |
| 3 | 21.7 | 17.8 |
| 4 | 18.8 | 13.4 |

The layer thickness and surface roughness of the coatings was as shown in Table 5. Lower surface roughness was obtained for the samples including SiO₂. Lower surface roughness generally corresponds to better mechanical robustness, such as better scratch resistance, as well as to better fouling resistance and better resistance to outdoor conditions (moisture and oxygen).

TABLE 5

| # | Sample | Layer thickness | | Surface roughness (Pq) | |
|---|---|---|---|---|---|
| 8 | VO₂ | 78.1 ± 9.8 | nm | 14.8 ± 1.0 | nm |
| 1 | VO₂ + SiO₂ | 35.5 ± 8.4 | nm | 7.9 ± 1.7 | nm |
| 12 | VO₂ + 3% WCl₆ | 110.8 ± 40.8 | nm | 17.7 ± 2.4 | nm |
| 5 | VO₂ + 3% WCl₆ + SiO₂ | 27.4 ± 6.1 | nm | 9.4 ± 1.8 | nm |

Measurement Methods

Method A: Switching Temperature and Transmission Modulation Value

The coatings were analysed using a Perkin Elmer UV/VIS/NIR Spectrometer Lambda 750 with UL150t, this is a spectrometer equipped with an upward looking 150 mm integrating sphere accessory with temperature controlled sample holder. The substrates were heated and cooled at a rate of 1° C./min at 2° C. intervals in a temperature range of 0° C. till 90° C. The subsequent transmission and reflection were measured between 250-2400 nm with 10 nm intervals. The temperature measurement was determined by placing a thermocouple at the coated side, which was facing the integrating sphere.

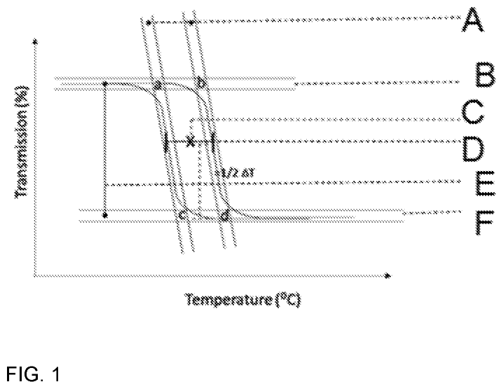

For the determination of the switching point, the transmission is plotted as function of temperature measured at 1600 nm, yielding a hysteresis plot. The hysteresis plot is then divided into four mathematical linear equations of which two are parallel to the temperature axes. The two remaining vertical linear equations are determined by fitting the upward curve and downward curve (see FIG. 1).

FIG. 1 illustrates an example schematic hysteresis plot of a thermochromic coating. In FIG. 1, A indicates Δ transmission<−0.1% & >0.1%, B indicates Δ transmission≥−0.1% & ≤0.1%, C indicates the switching point in ° C. at half hysteresis width, D indicates hysteresis width in ° C. at half ΔT, E indicates Δ transmission modulation value=ΔT, and F indicates Δ transmission≥−0.1% & ≤0.1%.

As illustrated in FIG. 1, determination of parallel is when the difference in gradient between 2 measured points at a 2° C. interval is ≥−0.1% transmission and ≤0.1% transmission. The definition of a vertical slope is determined when the gradient between 2 measured points at a 2° C. interval is <−0.1% transmission and >0.1% transmission.

The hysteresis width in ° C. is then determined via determining the points of tangency of the four resulting crossing points (depicted as the points a, b, c, and d in FIG. 1) of the linear equations. Subsequently the hysteresis width is determined by dividing the corresponding subtracting the low from the high transmission value and adding it to the low value for vertical cooling linear fit as for the vertical heating linear fit. The hysteresis width is then the corresponding temperature values subtracted from each other.

The switching point is the temperature (of the point X) at 50% hysteresis width (see FIG. 1). The transmission modulation value is the highest determined transmission value determined at the points of tangency minus the lowest determined point of tangency.

Layer Thickness

To determine the layer thickness the following method has been chosen: during the application method on a position on the substrate a piece of substrate is masked using Scotch® Magic™ tape from 3M, before annealing the coating this piece is removed leaving behind an uncoated part on the substrate. This is needed to measure the height difference between coating and substrate. Using a Dektak®XT benchtop stylus profilometer made by Bruker, this height difference is then determined. Settings used are: measurement range 6.5 μm; scan length 2000 μm; duration 20 seconds; stylus type 2 μm; stylus force 5 mg.

Method B: Surface Roughness

Surface roughness was measured using Dektak® XT benchtop stylus profilometer made by Bruker with stylus force of 2 mg, with a 2 μm stylus, B-type, red/white, for sample length 100 μm in 100 seconds. The discrimination height was 10% of Pz (average max. height) and the spacing was 1% of the sample length. The average roughness (Pq) was calculated based on 5 lengths.

### Example 2

Material used of coating substrates can also be isolated and annealed whilst retaining thermochromic properties. For example, the precursor is isolated and subsequently annealed to the material. The final material is a granular material. An example method to obtain such a granular material is as follows. A solution as described in Example 1 is evaporated till dryness, at 40° C. and 30 mbar using a rotational evaporator. Subsequently the residue is dried overnight at 40° C. and less than 50 mbar. The precursor is used as such. For annealing the dried material was placed in a Discovery classic TGA system from TA Instruments. The material is heated after an isothermal step at ambient temperature of 5 minutes with an heating rate of 50° C./min followed by an isothermal step of 10 minutes at 575° C., under a flow of 25 ml/min N₂ (>99.9 vol %).

The mixtures of Table 6 were prepared with this method.

TABLE 6

| Pigment # | Mixture A (g) | Mixture B (g) |
|---|---|---|
| 15 | 25 | 1 |
| 16 | 25 | 3 |
| 17 | 25 | 5.7 |
| 18 | 25 | 12 |

1. A thermochromic material comprising:
vanadium (IV) oxide and
a solid component obtained from a precursor having film-forming properties, wherein the thermochromic material exhibits a transmission increase in infrared (800-2400 nm) from above the switching temperature to below the switching temperature that is larger than said transmission increase for a reference material not including said solid component;
and/or wherein the thermochromic material exhibits a switching temperature that is at least 5° C. lower than for a reference material not including said solid component.

2. A thermochromic material according to claim 1, wherein the solid component comprises SiO₂, ZrO₂, TiO₂, Al₂O₃, HfO₂, MgF₂, CaF₂, an organosiloxane compound, or a mixture thereof.

3. The thermochromic material according to claim 1, further comprising a doping ion.

4. The thermochromic material according to claim 3, wherein the doping ion comprises an ion of Mo, W, Ta, Nb, Al, F, or a mixture of these ions.

5. The thermochromic material of claim 1, wherein the thermochromic material exhibits both a transmission increase in infrared (800-2400 nm) from above the switching temperature to below the switching temperature that is larger than said transmission increase for a reference material not including said solid component, and a switching temperature that is at least 5° C. lower than for a reference material not including said solid component.

6. The thermochromic material of claim 1, wherein the material comprises at least 25 vol. % VO₂ relative to the total material and at least 5 vol. % of said solid component relative to the total material.

7. The thermochromic material of claim 1, wherein the material comprises V to Si in an atomic ratio of 2 to 10.

8. A coated article comprising a substrate and the thermochromic material of claim 1 as a coating layer, preferably wherein the coating layer has a surface roughness (Pq) of less than 10 nm.

9. A composition comprising the thermochromic material of claim 1 as granular material.

10. A method of preparing a coated article comprising a substrate and a coating on the substrate, wherein the coating comprises vanadium (IV) oxide and silica, wherein the method comprises:
applying a coating formulation comprising a precursor of vanadium (IV) oxide and silica onto a substrate to give a coated substrate,
thermally treating the coated substrate under an atmosphere comprising oxygen at a level of less than 1000 ppm by volume and at a temperature of at least 350° C. for a period of less than 60 minutes.

11. The method according to claim 10, wherein the thermal treatment involves heating the coated substrate in less than 5000 seconds to a temperature above 400° C. at an oxygen level of less than 500 ppm by volume.

12. The method according to claim 11, wherein the thermal treatment comprises cooling the coated substrate, after said heating step, from a temperature of at least 400° C. to a temperature of less than 300° C. in a period of less than 1 hour.

13. The method of claim 10, giving the coated article according to claim 8.

14. A method of preparing a thermochromic material comprising vanadium (IV) oxide and silica, wherein the method comprises:
providing a formulation comprising a liquid medium, a precursor of vanadium (IV) oxide and silica,
drying said formulation to remove at least part of said liquid to give a dried material,
thermally treating the dried material under an atmosphere comprising oxygen at a level of less than 1000 ppm by volume and at a temperature of at least 350° C. for a period of less than 60 minutes.

15. Method of reducing the surface roughness of a thermochromic material comprising vanadium (IV) oxide, the method comprising: incorporating silica as additive in the thermochromic material comprising vanadium (IV) oxide.

16. A coated article comprising a substrate and a coating layer comprising a thermochromic material which comprises vanadium (IV) oxide and a solid component comprising SiO₂, ZrO₂, TiO₂, Al₂O₃, HfO₂, MgF₂, CaF₂, and/or an organosiloxane compound, wherein the coating layer has a surface roughness (Pq) of less than 10 nm.

17. A thermochromic material obtainable by the method of claim 14.

18. A film comprising particles of the thermochromic material of claim 1.
